(19) United States
(12) Patent Application Publication
(10) Pub. No.: US 2007/0082638 A1
(43) Pub. Date: Apr. 12, 2007

(54) Adaptive Narrowband Interference Canceller for Broadband Systems

(76) Inventors: Oleg Panfilov, Marina Del Rey, CA (US); Ronald Hickling, Newbury Park, CA (US); Antonio Turgeon, Agoura Hills, CA (US)

Correspondence Address: INTELLECTUAL PROPERTY LAW OFFICE OF JOEL VOELZKE, 400 CORPORATE POINTE, SUITE 300, CULVER CITY, CA, 90230, US

(21) Appl. No.: 11/468,688

(22) Filed: Aug. 30, 2006

Related U.S. Application Data
(60) Provisional application No. 60/713,921, filed on Sep. 3, 2005.

(51) Int. Cl. H04B 1/10; H04B 1/06

(52) U.S. Cl. 455/224; 455/242.1; 455/296

(57) ABSTRACT

An interference canceller for canceling narrowband interference from a received broadband signal takes advantage of the fact that the correlation time for the narrowband interference signal will be significantly greater than the correlation time for the desirable broadband signal. The interference canceller operates by creating a replica of the narrowband interference signal in an auixiliary channel and subtracts it from the main channel to cancel the interference. The auxiliary channel has a delay time larger than the correlation time of the desirable broadband signal. In-phase and quadrature versions of the delayed signal are multiplied by respective weights and subtracted from the received signal to produce an interference-reduced signal. The weights are are adjusted by an adaptive block to minimize the power in the interference-reduced output signal.

### CROSS-REFERENCE TO RELATED APPLICATIONS

This application claims priority from U.S. Provisional Patent Application No. 60/713.921 filed Sep. 3, 2005.

### BACKGROUND OF THE INVENTION

1. Field of the Invention

This invention relates to the field of broadband communications. More particularly, this invention relates to the field of an adaptive narrowband interference canceller for broadband systems.

2. Description of Related Art

Broadband communication systems are well known. Most modern cellular telephone systems, for example CDMA 2000 and wideband CDMA (WCDMA), use broadband signals requiring wideband front end receivers. However, the proliferation of multiple standards creates system interoperability problems, degrades efficiency of spectrum utilization, and increases the cost of communication services. One way to address the negative impact of operation in the multistandard environment is to provide direct downconversion from radio frequency (RF) to baseband frequency bands. By performing required signal processing in the digital domain after converting a signal to its digital equivalent at the baseband, a system becomes frequency agile as well as standard independent. However, making a system frequency agile and standard independent has accompanying drawbacks. The analysis of spectrum occupancy measurements in a broad range of frequencies has showed that design of direct conversion receivers providing conversion from RF to baseband poses its own challenges. One challenging stems from the necessity of maintaining linearity in broadband receivers in light of potentially unpredictable levels of outband or inband interference. Such interference can be seen from FIGS 1 and 2 showing typical spectral distribution statistics for the public safety and PCS bands in New York City, as reported in “Spectrum Occupancy Measurements, Location 4 of 6: Republication National Convention, New York City, N.Y. Aug. 30, 2004-Sep. 3, 2004, Revision 2,” Mark A. Henry, Dan McCloskey, and George Lane-Roberts. Shared Spectrum Company Report (August, 2005).

The development of wideband front end receivers is important to achieving frequency agility and realizing the desirable goal of ideal software definable radio (SDR) receivers. If the spectral band of a wideband receiver is given, and an interference source such as a broadcast AM or FM radio station having a defined and relatively narrow bandwidth is known, the received signal can be passed through a band stop filter that filters out the known interference source with a relatively small loss of integrity of the desired wideband signal. However, the desired information signal will still be degraded somewhat. Additionally, interference sources are rarely so well predefined and known. This problem is exacerbated when a radio frequency receiver is frequency agile, which makes it even more difficult to pre-characterize interference sources.

### SUMMARY OF THE INVENTION

The present invention addresses the problem of how to cancel a narrowband interference signal which is not known a priori from a received broadband signal, without impairing the desired signal. The invention takes advantage of the fact that narrowband interference signals have substantially larger correlation times than the desired signal component in a broadband receiver. The present invention cancels a narrowband interference signal by using an adaptive interference canceller to create an accurate replica of the interfering signal(s) in an auxiliary channel, the replica being equal in amplitude but counter in phase to the interfering signal, and subtracting the replica from the original received signal. By delaying signals in the auxiliary channel by a time that is larger than the correlation time of desirable signals, the signals in the main and auxiliary channels become practically uncorrelated while still maintaining high correlation for interfering signals.

The additional auxiliary channel is created by using a time delay line having a delay that is larger than the correlation time of the desirable signals. The auxiliary channel has two paths, one path which has no phase shift and one quadrature path which has a 90 degree phase shift, each path having a scalar multiplier or tap weight. The tap weights are adjusted by an adaptive process that minimizes the power in the output. Adaptive processes that minimize spectral power are, by themselves, well known. The two auxiliary channel interference components are then added back to the received signal. The result is that the auxiliary channel has produced a replica of the dominant narrowband interference signal, and that replica is subtracted from the received signal to produce the desired broadband signal with the dominant narrowband interference signal canceled therefrom.

The invention has applicability in general to adaptive cancellation of narrowband interference, including communication systems and audio systems.

In one aspect therefore, the invention is of an adaptive interference canceller for a broadband communication system having a first signal path for carrying a received broadband signal including a broadband communication signal, and an interference cancellation loop. The interference cancellation loop has a delay element having a delay time that is larger than the correlation time of the broadband communication signal for delaying the received broadband signal and producing a delayed version thereof, a signal multiplier which is preferably, a controllable gain amplifier having an adjustable weight value for producing a weighted delayed signal, an adaptive element for adjusting the weight value, and an adder for adding the received broadband signal and the weighted delayed signal to produce an interference reduced output signal. The interference cancellation loop includes both an in-phase and 90° phase shifted path, and respective circuitry forming tap weights for multiplying each of the in-phase and phase shifted signals. The interference canceller may be part of a radio frequency transmitter/receiver such as a frequency agile mobile telephone that is reprogrammable for compliance with a variety of different standards. The delay element may be adjusted for the different standards so that the delay time is always larger than the correlation time of the broadband communication signals for the selected standard.

In another aspect, the invention is of a method of canceling narrowband interference from a broadband channel, the broadband channel carrying a received broadband signal having a broadband information signal and narrowband interference. The method includes the steps of delaying the received broadband signal by a delay time that is greater than the correlation time of the broadband information signal to produce a delayed signal, producing a quadrature version of the delayed signal that is phase shifted by approximately 90° from the delayed signal, multiplying the delayed signal by a formed by a correlated feedback subsystem weight or factor to produce a weighted delayed signal, multiplying the quadrature version of the delayed signal by a second weight or factor to produce a weighted quadrature delayed signal, adding the two weighted signals to the received broadband signal to produce an interference-reduced version of the received broadband signal, whereby the narrowband interference is at least partially cancelled from the received broadband signal. The weights are adjusted to minimize the spectral power in the interference-reduced version of the received broadband signal. The method may further include the steps of reprogramming a demodulator after powering on the equipment to chance from a first communication standard to a second communication standard, and changing the delay time in accordance with the selected communication standard. The interference addressed by the present invention can also be thought of as noise. The invention can therefore also be considered to be a noise canceller.

Exemplary embodiments of the invention will be further described below with reference to the drawings, in which like numbers refer to like parts.

### BRIEF DESCRIPTION OF THE DRAWINGS

FIG. 1 is an amplitude histogram of power spectral densities within the public safety band, as reported in a recent study.

FIG. 2 is an amplitude histogram of the PCS band, as reported in a recent study.

FIG. 3 is a basic block diagram of an adaptive narrowband interference canceller according to a first embodiment of the present invention.

FIG. 4 is a basic block diagram of an adaptive narrowband interference canceller according to a second embodiment of the present invention having a digitally controlled auxiliary channel.

FIG. 5 is a simplified block diagram of an adaptive narrowband interference canceller for analysis purposes.

FIG. 6 is a simulation output of a narrowband interference canceller according to the present invention, showing a sharp reduction in narrowband interference as the canceller adapts the tap weights in the auxiliary channel.

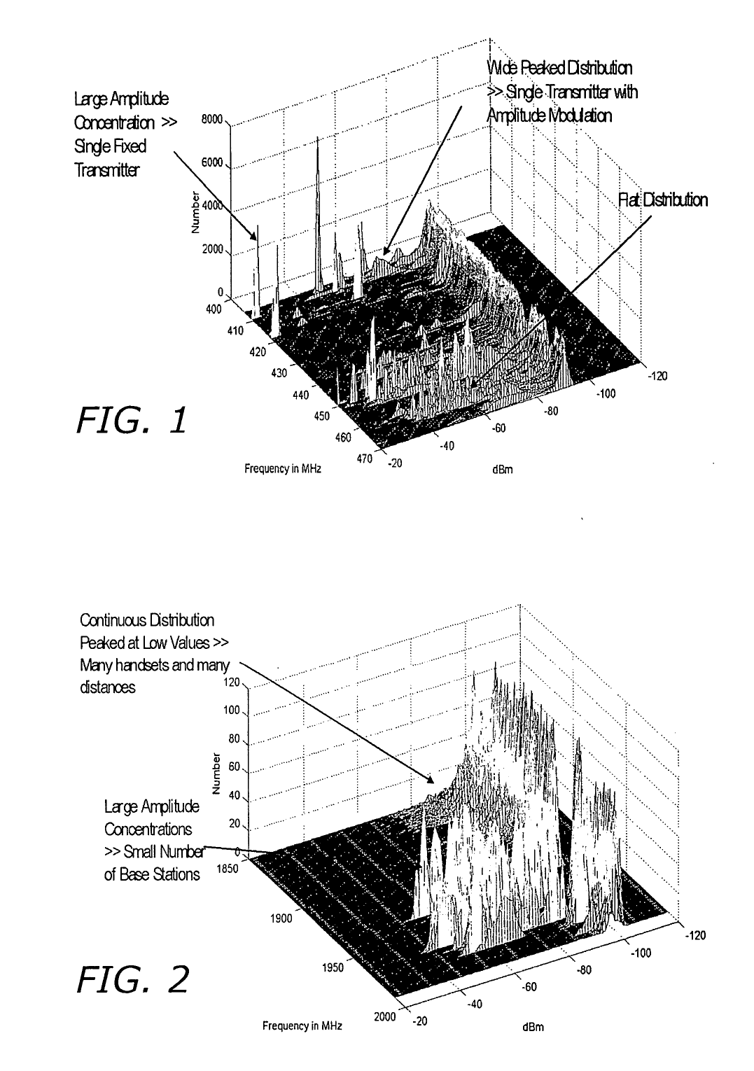

### DETAILED DESCRIPTION OF THE PREFERRED EMBODIMENTS

In the following detailed description of illustrative embodiments of the invention, various details are set forth in order to provide an understanding of the invention. It will be obvious to one skilled in the art, however, that the invention may be practiced without these specific details. In other instances well known methods, algorithms, procedures, components and circuits have not been described in detail so as not to unnecessarily obscure aspects of the invention.

The invention makes use of an auxiliary channel formed from the main channel by using a delay line and a correlated feedback loop adaptively adjusting the auxiliary channel tap weights to form a replica of narrowband main channel interference having the opposite sign.

Correlation defines the level of similarity of two random processes, Uₒᵢ(t) and U₁,(t). The coefficicent of correlation ρ(τ) is the normalized value of cross correlation function of these signals:

$$ρ ( τ ) = \frac{\overline{{U}_{oi} ( t ) \cdot {U}_{1 i} ( t - τ )}}{\sqrt{\overline{{U}_{0 t}^{2} ( t ) \cdot {U}_{1 t}^{2} ( t - τ )}}} , - 1 \leq ρ ( τ ) \leq 1.$$

−1≦ρ(τ)≦1. For the similar processes _{|ρ(0)|=1}.

The line over a function denotes the operation of averaging. Correlation time is defined at the level of −3 db of the signal autocorrelation function ρ(0). If two random processes are not absolutely similar the absolute value of the correlation coefficient will always be less than 1. Additional background theory and application of correlation functions can be found in Carl Helstrom, Probability and Stochastic Processes for Engineers (MacMillan Publishlinig Co. 1984). The correlation time is about 0.8 μsec for the IS95 standard and the CDMA 2000 standard, and about 0.2 μsec for WCDMA system. Operation in the WiFi or WiMAX environments will require delays corresponding to the correlation properties of their signals. Because signal bandwidths for these standards are wider than for the CDMA standards there is a broader difference in correlation properties between interference sources and signals corresponding to these standards. Correspondingly better interference suppression may be expected in operation with these signals. Cancellation of narrow band audio noise, such as for example 60 Hz line noise, will require setting the delay time inversely proportional to the interference spectrum width.

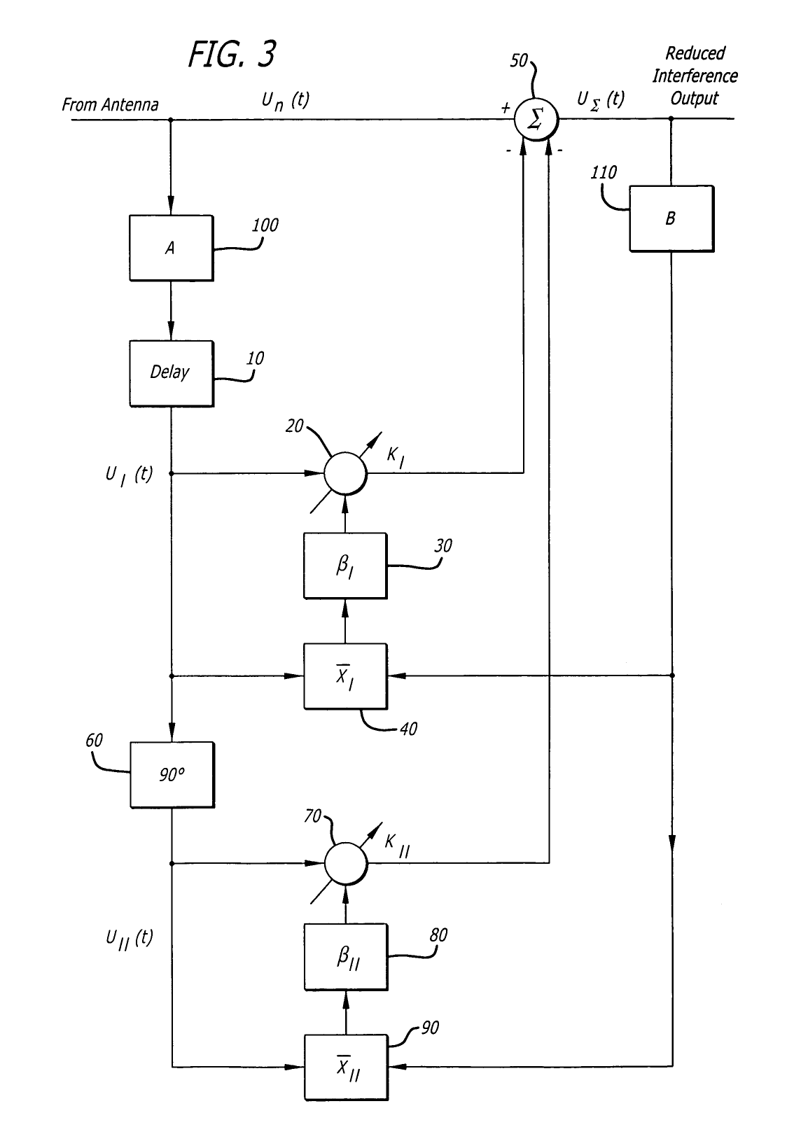

FIG. 3 is a block diagram of a narrowband interference canceller with quadrature auxiliary channels according to a first illustrative embodiment of the invention. The main channel signal U₀(t) goes to an amplification block 100 then to delay unit 10, and to adder 50. Delay unit 10 delays the signal by time T. The delay time T is selected to be larger than the correlation time of the selected broadband communication signal. Preferably, the delay T is selected to be at least 3 times larger than the correlation time of the selected broadband signal, and may be for example within the range of 2-5 times the correlation time of the selected broadband signal, or may be much higher, such as more than 10 times or more than 100 times the correlation time of the selected broadband communication signal. Preferably therefore, the delay is set to be at least 1.6 μsec for the IS95 standard and the CDMA 200 standard, and at least 0.5 μsec for the WCDMA standard.

The delayed signal U₁(t)=AU₀(t−T) goes to the controllable amplifier 20 having an amplification K₁, and to a correlator 40. Correlator 40 can be formed as a combination of a signal multiplier and a low pass filter. The auxiliary channel is formed by two quadrature subchannels by using a 90° phase shift block 60. Phase shift block 60 introduces an approximately and ideally 90° phase shift into each frequency component of signal U₁(t), i.e., a quarter period shift, regardless of frequency. Such phase shift blocks are well known in the literature. The in-phase component auxiliary subchannel multiplies the input voltage by coefficient K₁ which is adjusted adaptively by the correlated feedback loop. That loop uses correlator 40 and a controlled voltage amplifier 30 providing an amplification factor β₁ of a controlled signal to form the tap weight K₁ in controllable amplifier 20. Phase shifter 60 changes the phase of the auxiliary signal to become U₁₁(t) and forms the quadrature auxiliary subchannel with its own feedback correlated control subsystem having similar components as the in-phase auxiliary subchannel. The signal U₁₁(t) is amplified by tap weight K₁₁ in that subchannel. The required values of coefficients K₁ and K₁₁ are formed automatically by correlated feedback loops implementing mean square algorithms that minimize the total power in output U_{Σ}(t), which reduces or ideally eliminates entirely the interference signal from U₀(t). Principles and theory of adaptive signal processing and adaptive loops that minimize output spectral power can be found in, for example, Bernard Widrow and Samuel D. Stearns, Adaptive Signal Processing (Prentice-Hall, Inc. 1985).

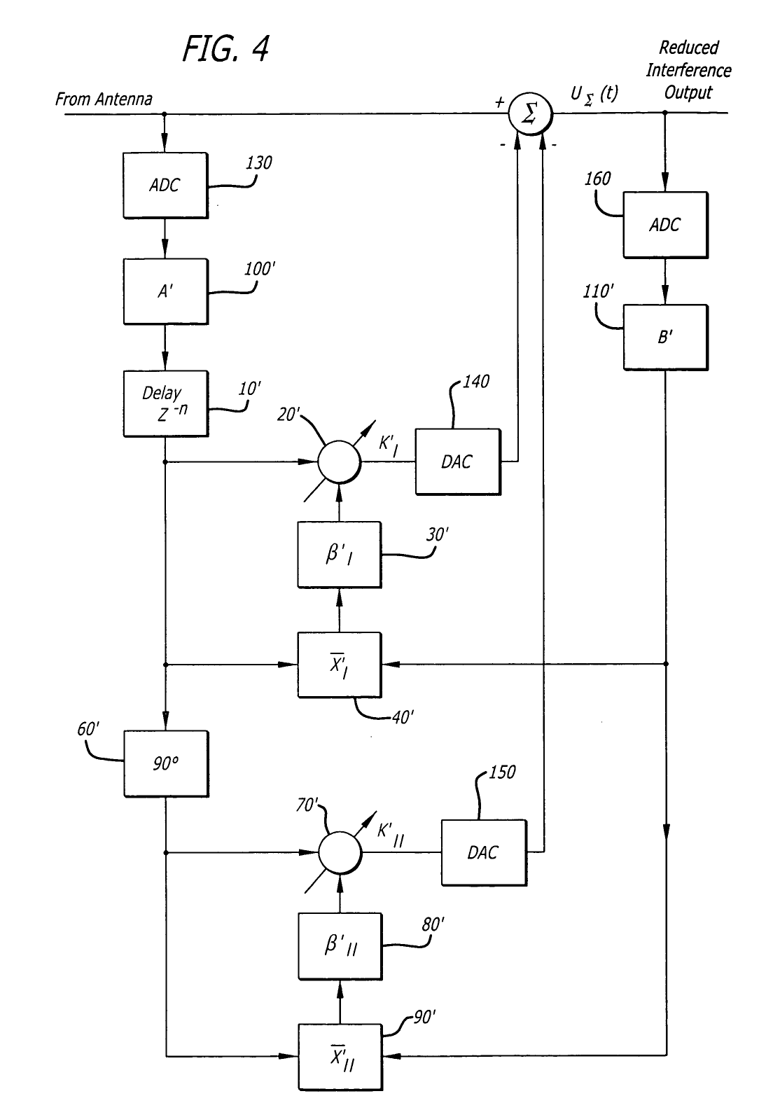

FIG. 4 is a block diagram of a second embodiment of the present invention. FIG. 4 is similar to FIG. 3 except that the interference canceller is implemented in the digital domain. Here the feedback control loops have an analog-to-digital converter (ADC) 130 to convert the incoming signal to the digital domain. The amplifier blocks 100′, 30′, 80′ and 110′; the correlator blocks 40′ and 90′; the delay block 10′; and the 90° phase shift block 60′ are all implemented in the digital domain. Digital-to-analog converters (DACs) 140 and 150 convert the in-phase and quadrature portions of the auxiliary channel to analog. Finally, ADC 160 converts the reduced interference output signal U_{Σ}(t) to its digital equivalent. Alternatively, an ADC could digitize the incoming signal from the antenna, and the entire interference canceller could be implemented using digital components. This would be particularly advantageous if the reduced interference output signal is to be processed next in digital form. In a digital implementation, the resolution of the ADCs employed should be such that the quantization noise does not contribution significantly to the reduction of correlation properties of the interfering signals.

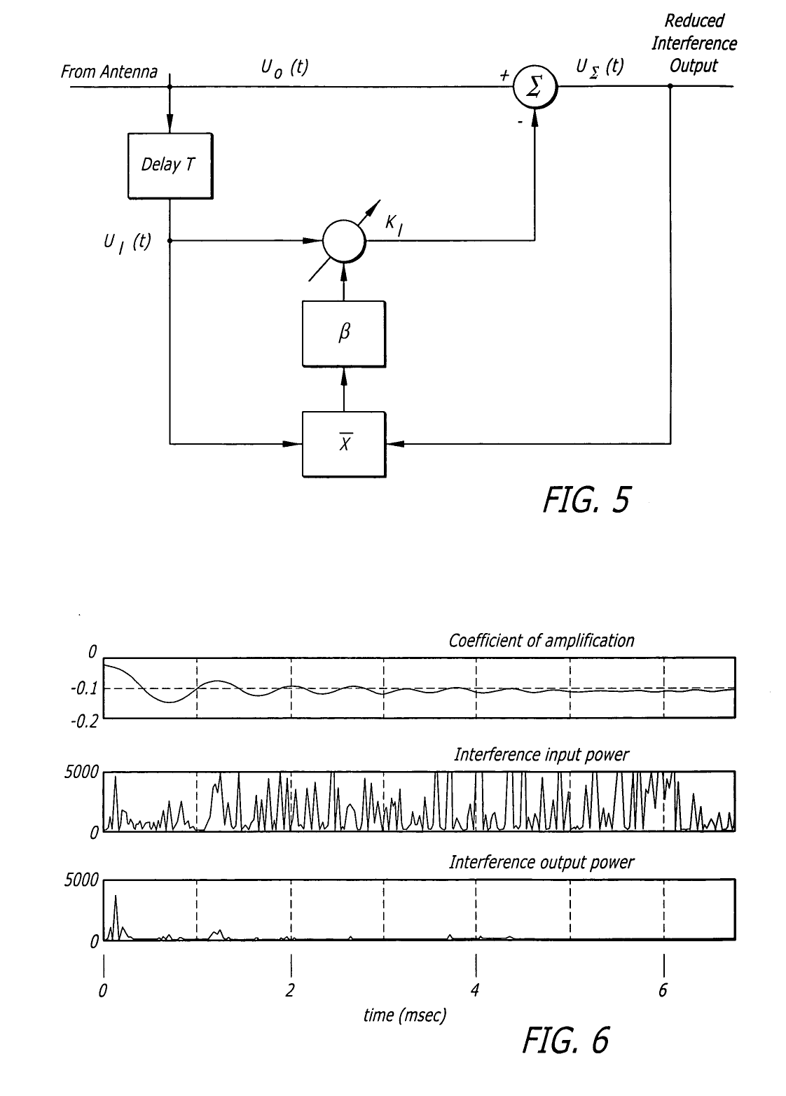

To facilitate the understanding of the underlying principle of this invention, we may rely on the interference canceller shown in FIG. 5, which is an idealized version of FIG. 3 with a simplified auxiliary channel. The signal in the main channel is the combination of signals from the desirable source U₀ₛ(t) and interference U₀ᵢ(t)
U₀(l)=U₀(t )+Uₒₜ(t) (1)
The signal in the auxiliary channel Uₗ(t) will be
Uₗ(t)=Uₒ(t−T) (2)
The delay time T is selected in such way that prevents correlation of desirable signal components from different channels

$$\overline{{U}_{os} ( t ) \cdot {U}_{os} ( t - T )} = 0 , \qquad ( 3 )$$

where a bar over the function denotes the operation of averaging.

The amplification coefficient of controllable amplifier Kₗ will be:

$${K}_{1} = β \overline{{U}_{0} ( t ) {U}_{Σ} ( t )} \qquad ( 4 )$$

where the signal at the adder output is
U_{Σ}(t)=U₀(t)+K₁U₁(t) (5)
Substituting (5) and (1)-(3) into (4) yields:

$${K}_{1} = β \frac{\overline{{U}_{oi} ( t ) \cdot {U}_{1 i} ( t - T )}}{1 - β \overline{{U}_{1 t}^{2} ( t )}} \qquad ( 6 )$$

Selecting the control signal amplification β such that even for the smallest power of interfering signal the condition β U̅ₗ̅ₜ̅ₘ̅ᵢ̅ₙ̅²̅(̅t̅)̅>>1 holds true, Eq (6) could be simplified as:

$${K}_{1} = \frac{\overline{{U}_{oi} ( t ) \cdot {U}_{oi} ( t - T )}}{- \overline{{U}_{1 i}^{2} ( t )}} \qquad ( 7 )$$

Substituting (7) into (5), the average power of interference at the output of adder will be

$$\overline{{U}_{Σ i}^{2} ( t )} = \overline{{U}_{0 i}^{2} ( t )} ( 1 - {ρ}^{2} ) \qquad ( 8 )$$

where the coefficient of correlation between interference signals in the main and auxiliary channels is equal to:

$$ρ = \frac{\overline{{U}_{oi} ( t ) \cdot {U}_{1 i} ( t )}}{\sqrt{\overline{{U}_{0 i}^{2} ( t )} \cdot \overline{{U}_{1 i}^{2} ( t )}}} \qquad ( 9 )$$

The coefficient of interference suppression K₂ can be defined as the ratio of interference power in the main channel to the interference power at the output of summer. It can be easily found from (8):

$${K}_{s} - \frac{1}{1 - {ρ}^{2}} \qquad ( 10 )$$

In the embodiments described above, the quadrature portion of the auxiliary channels allow the effectiveness of the interference canceller to be independent of the phase shifts between interference signals in the main and auxiliary channels regardless of the selected value of delay time T. An auxiliary channel which uses only an in-phase path would work effectively only if the delay time were an integer multiple of the interference carrier periods. The value of the coefficient A of amplification in block 10 in FIG. 3 may be selected based on a worst case scenario when its partial compensation may occur. That scenario, which should be a very unusual scenario, occurs when random phases of a desirable and interfering signals happen to be the same. The amplifier in the feedback loop with the coefficient of amplification A will keep an amplitude of the desirable output signal within the range:

$$( 1 - \frac{1}{A} ) \leq Amplitude \leq ( 1 + \frac{1}{A} )$$

Selection of A=20 dB will limit loss as specified above to 10%. An amplification of 20 dB should he sufficient in most cases.

Preferably, the total amplification of the feedback control loop of FIG. 3, A·B·β₁ is selected in a way that the average power of amplified interfering signal in the feedback control loop satisfies the relation A·B·β₁· U̅ₘ̅ᵢ̅ₙ̅²̅(̅t̅)̅>>1.

To provide comparable amplitude values of the feedback voltages at the input of the correlator, it is recommended to have the coefficient of amplification of a feedback control amplifier at the output of a summer equal to selected coefficient of interference suppression.

FIG. 6 is a simulation output of a narrowband interference canceller having a simplified auxiliary channel according to the present invention, showing the sharp reduction in narrowband interference as the canceller adapts the tap weights in the auxiliary channel. The upper trace shows the settling of the controllable amplifier coefficient of amplification (the weight to form the replica of the interfering signal in the auxiliary channel). Note that the coefficient can have a negative value. The middle trace depicts the power of the interference signal in the main channel before interference cancellation has taken place. The lower trace shows what is left after interference cancellation. It shows that after about 2.5 msec only negligible interference is left.

The present invention may be implemented in a broadband communication receiver, such as used in radio frequency transmitter/receiver equipment such as mobile telephones including frequency agile cellular telephones. In such equipment, the equipment is not confined to using a single communication standard. Instead, after the unit is powered on the unit including the modulator and demodulator portions can be commanded via software, i.e., reprogrammed, to change to another communication standard having another communication frequency band, center frequency, and/or modulation type. A memory stores various parameters associated with the communication standard to enable the transmitter/receiver to operate according to a selected one of the standards. When the unit is commanded to change standards, the delay value in the auxiliary channel loop is changed to the appropriate value for the new selected standard. The present invention works best when the narrowband interference has a bandwidth of at least an order of magnitude less than the bandwidth of the wideband communication signal.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

We claim:

1. An adaptive interference canceller for a broadband communication system comprising:
a first signal path for carrying a received broadband signal including a broadband communication signal said broadband communication signal having a correlation time associated therewith:
an interference cancellation loop comprising:
a delay element having a delay time associated therewith for delaying said received broadband signal and producing a delayed signal, said delayed signal being a delayed version of said received broadband signal;
a signal multiplier having a weight value associated therewith for receiving said delayed signal and producing a weighted delayed signal;
an adaptive element for adjusting said weight value;
an adder for adding said received broadband signal and said weighted delayed signal to produce an interference reduced output signal;
wherein said delay time is longer than the correlation time of said broadband communication signal.

2. A radio frequency transmitter/receiver having the adaptive interference canceller of claim 1.

3. The radio frequency transmitter/receiver of claim 2 wherein said transmitter/receiver is a frequency agile transmitter/receiver further comprising:
a memory for storing parameters associated with each of a plurality of radio frequency communication standards; and
wherein said delay element is adjusted according to a selected one of said plurality of radio frequency communication standards.

4. A method of canceling narrowband interference from a broadband channel, the broadband channel carrying a received broadband signal having a broadband information signal and narrowband interference, the broadband information signal having a correlation time associated therewith, the method comprising:
delaying the received broadband signal by a delay time greater than the correlation time of the broadband information signal to produce a delayed signal:
producing a quadrature version of the delayed signal, said quadrature version being phase shifted by approximately 90 degrees from the delayed signal;
multiplying the delayed signal by a first factor to produce a weighted delayed signal;
multiplying the quadrature version of the delayed signal by a second factor to produce a weighted quadrature delayed signal;
adding the weighted delayed signal and the weighted quadrature delayed signal to the received broadband signal to produce an interference-reduced version of said received broadband signal:
whereby said narrowband interference is at least partially cancelled from said received broadband signal.

5. The method of claim 4 further comprising:
reprogramming a demodulator to change from a first communication standard to a second communication standard; and
changing said delay time in accordance with said second communication standard.

6. The method of claim 4 further comprising:
adjusting said first factor and said second factor according to an adaptive process that seeks to minimize spectral power in said interference-reduced version of said received broadband signal.

7. The method of claim 4 further comprising:
after powering on a broadband receiver, selecting a communication mode;
selecting said delay time in accordance with said selected communication mode.

8. The method of claim 4 wherein: said delay time is at least twice said correlation time of said broadband communication signal.

9. The method of claim 8 wherein:
said delay time is selected to be within the range of 2-10 times said correlation time of said broadband communication signal.

10. A broadband radio frequency receiver having a narrowband interference canceller that operates according to the method of claim 4.

11. A mobile telephone having a narrowband interference canceller that operates according to the method of claim 4.

12. A mobile radio frequency transmitter/receiver having a narrowband interference canceller that operates according to the method of claim 4.

13. The mobile radio frequency transmitter/receiver of claim 12, wherein the narrowband interference comprises a broadcast AM or FM radio station signal.

14. The method of claim 4 wherein said delay time corresponds to a width of an interference spectrum.

15. The method of claim 4 wherein said correlation time is measured at the level of −3 dB of the signal autocorrelation function.

16. The method of claim 9 wherein said correlation time is measured at the level of −3 dB of the signal autocorrelation function.

17. An adaptive interference canceller comprising:
a first signal path for carrying a first signal, said first signal having a correlation time associated therewith:
a interface cancellation loop comprising:
a delay element having a delay time associated therewith for delaying said first signal and producing a delayed first signal;
a first multiplier having a first weight value associated therewith for receiving said delayed signal and producing a weighted delayed signal;
a first adaptive element for adjusting said first weight value;
an adder for adding said first signal and said weighted delayed signal to produce an interference reduced output signal;
wherein said delay time is longer than the correlation time of said first signal.

18. The adaptive interference canceller of claim 17 further comprising:
a phase shifter for shifting the delayed first signal and producing a phase shifted delayed first signal; and
a second multiplier having an adaptively adjusted second weight value associated therewith for receiving said phase shifted delayed first signal and producing a weighted phase shifted delayed signal.

19. The adaptive interference canceller of claim 18 wherein said delay is at least twice the correlation time of the first signal.

20. The adaptive interference canceller of claim 18 wherein the delay time is selected from the group consisting of:
at least 1.6 microseconds if the first signal is either an IS95 or CDMA 2000 signal; and
at least 0.5 microseconds if the first signal is a WCDMA signal.
